(19) United States
(12) Patent Application Publication
(10) Pub. No.: US 2026/0127599 A1
(43) Pub. Date: May 7, 2026

(54) METHOD AND SYSTEM FOR PAYMENT RECIPIENT MANAGEMENT ACROSS INSTITUTIONS

(71) Applicant: JPMorgan Chase Bank, N.A., New York, NY (US)

(72) Inventors: Tushar Vishnupant RAJE, Delaware, OH (US); Harish Pramod AGRAWAL, Lewis Center, OH (US)

(73) Assignee: JPMorgan Chase Bank, N.A., New York, NY (US)

(21) Appl. No.: 18/936,589

(22) Filed: Nov. 4, 2024

(51) Int. Cl. G06Q 20/40; G06Q 20/10; G06Q 20/38

(52) U.S. Cl. CPC G06Q 20/4014; G06Q 20/108; G06Q 20/382

(57) ABSTRACT

A method and a system for managing and accessing recipient information between institutions are provided. The method includes: receiving a request from an entity to transfer data associated with a recipient between a first financial institution and a second financial institution; authenticating an identity of the entity with the first financial institution; verifying permission to respond to the request with the first financial institution; determining whether the second financial institution is registered for a transfer; generating a first token that is shared with the first financial institution; transmitting the first token to the second financial institution for executing the transfer with the second financial institution; replicating the first data within the second financial institution; and assigning the first data to a first account within the second financial institution associated with the entity.

### BACKGROUND

### 1. Field of the Disclosure

This technology generally relates to methods and systems for managing and accessing recipient information between institutions, and more particularly to methods and systems for easily transferring, accessing, and managing recipient details across multiple financial institutions.

### 2. Background Information

As a financial institution (FI) or FI client (either consumer or corporate), accessing and managing recipient details across payments rails (i.e., real-time payment systems) is not readily available. FIs, their clients, and their recipients do not have a centralized system to manage cross FI recipient details and customize the payment rails. Ultimately, this lack of integration discourages clients and prospective clients from opening new accounts, as there is not a centralized way to transfer and manage payment and recipient information between accounts at separate FIs.

The problem is also noticed during merger and acquisitions, where a considerable amount of time and money needs to be invested to figure out recipient association to client identifiers. Looking at recipients (i.e., counter parties) as purely beneficiary tenants for FIs and their clientele, there is opportunity to make the recipient as a shared tenant across multiple FIs and their clientele for better reach and simplification of the payment rails. Thus, current technological systems lack the ability to solve these recipient data migration issues and result in inefficient system resource usage issues due to the lack of integration among different FIs.

Accordingly, there is a need for easily transferring, accessing, and managing recipient details across multiple financial institutions.

### SUMMARY

The present disclosure, through one or more of its various aspects, embodiments, and/or specific features or sub-components, provides, inter alia, various systems, servers, devices, methods, media, programs, and platforms for easily transferring, accessing, and managing recipient details across multiple financial institutions. According to an aspect of the present disclosure, a method for managing and accessing recipient information between institutions is provided. The method may be implemented by at least one processor. The method may include: receiving, by the at least one processor, a request from an entity to transfer first data associated with a recipient between a first financial institution and a second financial institution; authenticating, by the at least one processor, an identity of the entity with the first financial institution; when the identity of the entity is authenticated, verifying, by the at least one processor, permission to respond to the request with the first financial institution; when the permission is verified, determining, by the at least one processor, whether the second financial institution is registered for a transfer; when a determination is made that the second financial institution is registered, generating, by the at least one processor, a first token that is shared with the first financial institution; transmitting, by the at least one processor, the first token to the second financial institution for executing the transfer with the second financial institution; when the first token is received by the second financial institution, replicating, by the at least one processor, the first data within the second financial institution; and assigning, by the at least one processor, the first data to a first account within the second financial institution associated with the entity.

The method may further include displaying, by the at least one processor via a graphical user interface (GUI), the recipient data. The recipient data may be modifiable via the GUI. A modification to the recipient data may be synchronized between the first financial institution and the second financial institution.

The method may further include adding, by the at least one processor, transaction metadata to the first token to be used for assessing a validity and a possibility of a potential risk during the executing of the transfer.

The first token may be shared with the entity, and the entity may transmit the first token and an identity credential to the second institution for the executing of the transfer.

The method may further include generating, by the at least one processor, a notification upon completion of at least one from among the transmitting, the replicating, and the assigning. The notification may be transmitted to at least one from among the entity, the first financial institution, and the second financial institution.

The method may further include generating, by the at least one processor, an invitation for the recipient to register and provide at least one detail associated with the recipient. The at least one detail may include at least one from among account information associated with the recipient and transmittal information associated with the recipient.

The first data may include information regarding a preferred mode of transmitting payment, wherein the preferred mode of transmitting payment is selected from among an electronic money transfer across an automated clearing house (ACH), a wire transfer, and a real-time payments (RTP) electronic money transfer.

The method may further include transmitting, by the at least one processor, a payment from the first account to a second account associated with the recipient based on the first data.

The method may further include offering, by the at least one processor, to provide at least one from among a dedicated data tenancy and a shared data tenancy to at least one from among the first financial institution and the second financial institution.

According to another aspect of the present disclosure, a computing apparatus for managing and accessing recipient information between institutions is provided. The computing apparatus may include a processor; a memory; and a communication interface coupled to each of the processor, and the memory. The processor may be configured to: receive, via the communication interface, a request from an entity to transfer first data associated with a recipient between a first financial institution and a second financial institution; authenticate an identity of the entity with the first financial institution; when the identity of the entity is authenticated, verify permission to respond to the request with the first financial institution; when the permission is verified, determine whether the second financial institution is registered for a transfer; when a determination is made that the second financial institution is registered, generate a first token that is shared with the first financial institution; transmit, via the communication interface, the first token to the second financial institution for executing the transfer with the second financial institution; when the first token is received by the second financial institution, replicate the first data within the second financial institution; and assign the recipient data to a first account within the second financial institution associated with the entity.

The processor may be further configured to display, via a GUI, the recipient data. The recipient data may be modifiable via the GUI. A modification to the recipient data may be synchronized between the first financial institution and the second financial institution.

The processor may be further configured to add transaction metadata to the first token to be used for assessing a validity and a possibility of a potential risk during the executing of the transfer.

The first token may be shared with the entity. The entity may transmit, via the communication interface, the first token and an identity credential to the second institution for the executing of the transfer.

The processor may be further configured to generate a notification upon completion of at least one from among the transmitting, the replicating, and the assigning. The notification may be transmitted to at least one from among the entity, the first financial institution, and the second financial institution.

The processor may be further configured to generate an invitation for the recipient to register and provide at least one detail associated with the recipient. The at least one detail may include at least one from among account information associated with the recipient and transmittal information associated with the recipient.

The first data may include information regarding a preferred mode of transmitting payment. The preferred mode of transmitting payment may be selected from among an electronic money transfer across an ACH, a wire transfer, and an RTP electronic money transfer.

The processor may be further configured to transmit, via the communication interface, a payment from the first account to a second account associated with the recipient based on the first data.

The processor may be further configured to offer to provide at least one from among a dedicated data tenancy and a shared data tenancy to at least one from among the first financial institution and the second financial institution.

According to yet another aspect of the present disclosure, a non-transitory computer readable storage medium storing instructions for managing and accessing recipient information between institutions is provided. The storage medium includes executable code which, when executed by a processor, may cause the processor to: receive a request from an entity to transfer first data associated with a recipient between a first financial institution and a second financial institution; authenticate an identity of the entity with the first financial institution; when the identity of the entity is authenticated, verify permission to respond to the request with the first financial institution; when the permission is verified, determine whether the second financial institution is registered for a transfer; when a determination is made that the second financial institution is registered, generate a first token that is shared with the first financial institution; transmit the first token to the second financial institution for executing the transfer with the second financial institution; when the first token is received by the second financial institution, replicate the first data within the second financial institution; and assign the recipient data to a first account within the second financial institution associated with the entity.

The executable code may further cause the processor to display, via a GUI, the recipient data. The recipient data may be modifiable via the GUI. A modification to the recipient data may be synchronized between the first financial institution and the second financial institution.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for easily transferring, accessing, and managing recipient details across multiple financial institutions, according to an embodiment.

FIG. 2 illustrates a diagram of a network environment for easily transferring, accessing, and managing recipient details across multiple financial institutions, according to an embodiment.

FIG. 3 illustrates a system diagram of a system for easily transferring, accessing, and managing recipient details across multiple financial institutions, according to an embodiment.

FIG. 4 illustrates a process diagram of a process for easily transferring, accessing, and managing recipient details across multiple financial institutions, according to an embodiment.

FIG. 5 illustrates a technical design and flow diagram for easily transferring, accessing, and managing recipient details across multiple financial institutions, according to an embodiment.

FIG. 6 illustrates an FI and client registration flow diagram for easily transferring, accessing, and managing recipient details across multiple financial institutions, according to an embodiment.

FIG. 7 illustrates a client request recipient replication flow diagram for easily transferring, accessing, and managing recipient details across multiple financial institutions, according to an embodiment.

FIG. 8 illustrates an FI merger and acquisitions flow diagram for easily transferring, accessing, and managing recipient details across multiple financial institutions, according to an embodiment.

FIG. 9 illustrates a recipient notification and registration flow diagram for easily transferring, accessing, and managing recipient details across multiple financial institutions, according to an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units, and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or similar, they may be programmed using software (e.g., microcode) to perform various functions discussed herein and may optionally be driven by firmware and/or software. Alternatively, each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of the example embodiments may be physically separated into two or more interacting and discrete blocks, units, and/or modules without departing from the scope of the inventive concepts. Further, the blocks, units and/or modules of the example embodiments may be physically combined into more complex blocks, units, and/or modules without departing from the scope of the present disclosure.

A system or method disclosed herein increases speed, efficiency, and ease of transferring recipient account details between FIs. Particularly, when a client wants to switch accounts or FIs for making payments to a particular recipient, the system receives a request to transfer the recipient details from the original account to the new account. The system then authenticates the identity of the client with the FI associated with the original account and verifies permission to respond to the request when the identity is authenticated. Once the permission is verified the system determines whether the FI associated with the new account is registered for the transfer. If the FI is registered, the system generates a digital token that is shared with the FI associated with the original account. The system then transmits the token to the FI associated with the new account. Once the FI associated with the new account receives the token, the recipient details from the original account are replicated in the new account. This system creates a common repository for all recipient data in a central location and decouples validation and maintenance from FI payment products. The system may be available as a packaged software offering for all FI systems to securely create, transfer, update, delete, read, and manage recipient information. Additionally, this system may be integrated with various payments options supported by FIs and provide a secure way for user/FIs to import/export their recipient details across FIs. The systems use of a common recipient repository eases the recipient migration process during merger and acquisitions. This system is also particularly beneficial for entities to register as a recipient and make themselves easily accessible to clients. Moreover, the system may enable the recipient to provide a preference for selecting a payment rail for certain transactions (e.g., FIs/client can customize the type or source of payment). Thus, this system improves the ease of transferring, accessing, and managing recipient details across multiple financial institutions, thereby improving data migration/integration and reducing system resource usage issues.

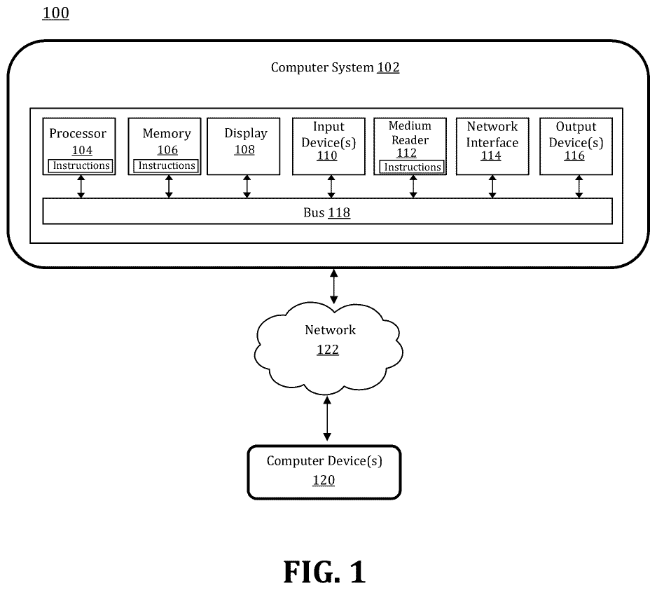

FIG. 1 is a system 100 for easily transferring, accessing, and managing recipient details across multiple financial institutions, in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks, or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In an embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, and serial advanced technology attachment.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 may be a personal computer. However, those skilled in the art appreciate that, in alternative embodiments of the present application, the computer device 120 may also be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the recipient management module implemented by the system 100 may allow for easy transferring, accessing, and managing of recipient details across multiple financial institutions. The configuration or data files, in some embodiments, may be written using JavaScript Object Notation (JSON), but the disclosure is not limited thereto. For example, the configuration or data files may easily be extended to other readable file formats such as Extensible Markup Language (XML), Yet Another Markup Language (YAML), or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionalities as described herein, and a processor described herein may be used to support a virtual processing environment.

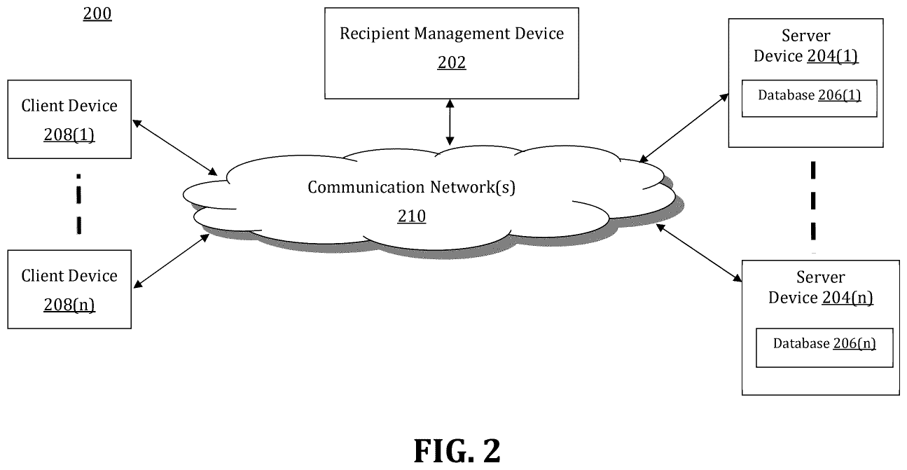

Referring to FIG. 2, a schematic of a network environment 200 for easily transferring, accessing, and managing recipient details across multiple financial institutions is illustrated.

In some embodiments, the above-described problems associated with conventional tools may be overcome by implementing a recipient management device 202 as illustrated in FIG. 2 that may be configured for easily transferring, accessing, and managing recipient details across multiple financial institutions, but the disclosure is not limited thereto.

The recipient management device 202 may include one or more computer systems 102, as described with respect to FIG. 1, which in aggregate provide the necessary functions.

The recipient management device 202 may store one or more applications that can include executable instructions that, when executed by the recipient management device 202, cause the recipient management device 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the recipient management device 202 itself, may be located in virtual server(s) running in a cloud-based computing environment rather than being tied to one or more specific physical network computing devices. Also, the application(s) may be running in one or more virtual machines (VMs) executing on the recipient management device 202. Additionally, in one or more embodiments of this technology, virtual machine(s) running on the recipient management device 202 may be managed or supervised by a hypervisor.

In the network environment 200 of FIG. 2, the recipient management device 202 may be coupled to a plurality of server devices 204(1)-204(n) that hosts a plurality of databases 206(1)-206(n), and also to a plurality of client devices 208(1)-208(n) via communication network(s) 210. A communication interface of the recipient management device 202, such as the network interface 114 of the computer system 102 of FIG. 1, operatively couples and communicates between the recipient management device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the recipient management device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use Transmission Control Protocol/Internet Protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The recipient management device 202 may be a standalone device or integrated with one or more other devices or apparatuses, such as one or more of the server devices 204(1)-204(n), for example. In one example, the recipient management device 202 may be hosted by one of the server devices 204(1)-204(n), and other arrangements are also possible. Moreover, one or more of the devices of the recipient management device 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the recipient management device 202 via the communication network(s) 210 according to the Hypertext Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the recipient management device 202 that may ease the transferring, accessing, and managing of recipient details across multiple financial institutions, but the disclosure is not limited thereto.

The client devices 208(1)-208(n) may run interface applications, such as standard web browsers or standalone client applications, which may provide an interface to communicate with the recipient management device 202 via the communication network(s) 210 in order to communicate user requests. The client devices 208(1)-208(n) may further include, among other features, a display device, such as a display screen or touchscreen, and/or an input device, such as a keyboard, for example.

Although the network environment 200 with the recipient management device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the recipient management device 202, the server devices 204(1)-204(n), or the client devices 208(1)-208(n), for example, may be configured to operate as virtual instances on the same physical machine. For example, one or more of the recipient management devices 202, the server devices 204(1)-204(n), or the client devices 208(1)-208(n) may operate on the same physical device rather than as separate devices communicating through communication network(s) 210. Additionally, there may be more or fewer recipient management devices 202, server devices 204(1)-204(n), or client devices 208(1)-208(n) than illustrated in FIG. 2. In some embodiments, the recipient management device 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

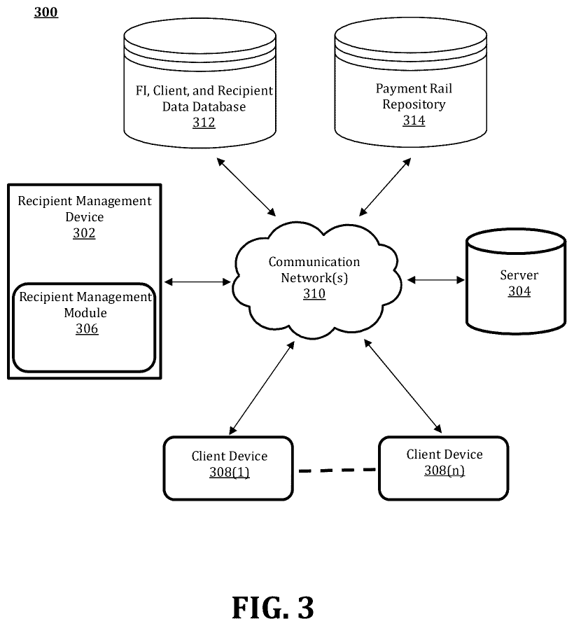

FIG. 3 illustrates a system diagram for easily transferring, accessing, and managing recipient details across multiple financial institutions in accordance with an embodiment.

As illustrated in FIG. 3, the system 300 may include a recipient management device 302 within which an recipient management module 306 is embedded, a server 304, a FI client and recipient data database 312, a payment rail repository 314, a plurality of client devices 308(1) . . . 308(n), and a communication network 310.

In some embodiments, the recipient management device 302 including the recipient management module 306 may be connected to the server 304, the FI, client, and recipient data database 312, and the payment rail repository 314 via the communication network 310. The recipient management device 302 may also be connected to the plurality of client devices 308(1) . . . 308(n) via the communication network 310, but the disclosure is not limited thereto. The FI, client, and recipient data database 312 and the payment rail repository 314 may include one or more repositories or databases.

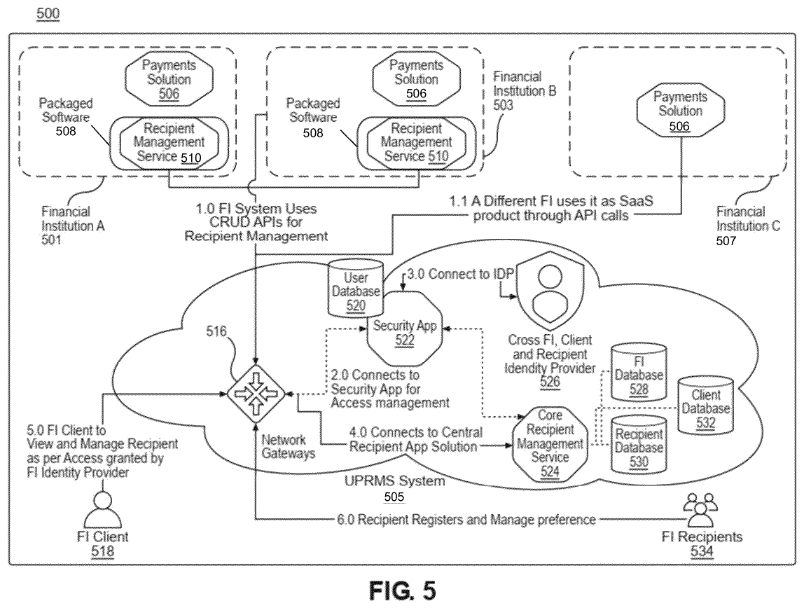

In an embodiment, the recipient management device 302 is described and shown in FIG. 3 as including the recipient management module 306, although it may include other rules, policies, modules, databases, or applications, for example. In some embodiments, the FI, client, and recipient data database 312 and the payment rail repository 314 may be configured to store ready to use modules written for each API for all environments. Although only one database and one repository are illustrated in FIG. 3, the disclosure is not limited thereto. Any number of desired databases and/or repositories may be utilized for use in the disclosed invention herein. The FI, client, and recipient data database 312 and the payment rail repository 314 may be a mainframe database, a log database that may produce programming for searching, monitoring, and analyzing machine-generated data via a web interface, but the disclosure is not limited thereto. The FI, client, and recipient data database 312 may include a combination of separate databases, including an FI database 528, a client database 532, and a recipient database 530, as illustrated in FIG. 5. In addition, the FI, client, and recipient data database 312 and the payment rail repository 314 may store a plurality of data sets and predictive models for managing and accessing recipient information.

In some embodiments, the recipient management module 306 may be configured to receive real-time feed of data from the plurality of client devices 308(1) . . . 308(n) and secondary sources via the communication network 310.

The recipient management module 306 may be configured to: receive, via the communication interface, a request from an entity to transfer first data associated with a recipient between a first financial institution and a second financial institution; authenticate an identity of an entity with the first financial institution; when the identity of the entity is authenticated, verify permission to respond to the request with the first financial institution; when the permission is verified, determine whether the second financial institution is registered for a transfer; when a determination is made that the second financial institution is registered, generate a first token that is shared with the first financial institution; transmit, via the communication interface, the first token to the second financial institution for executing the transfer with the second financial institution; when the first token is received by the second financial institution, replicate the first data within the second financial institution; and assign the recipient data to a first account within the second financial institution associated with the entity.

The plurality of client devices 308(1) . . . 308(n) are illustrated as being in communication with the recipient management device 302. In this regard, the plurality of client devices 308(1) . . . 308(n) may be “clients” (e.g., customers) of the recipient management device 302 and are described herein as such. Nevertheless, it is to be known and understood that the plurality of client devices 308(1) . . . 308(n) need not necessarily be “clients” of the recipient management device 302, or any entity described in association therewith herein. Any additional or alternative relationship may exist between either or both plurality of client devices 308(1) . . . 308(n) and the recipient management device 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the pluralities of client devices 308(1) . . . 308(n) may communicate with the recipient management device 302 via broadband or cellular communication. Of course, these embodiments are merely exemplary and are not limiting or exhaustive.

The client devices 308(1)-308(n) may be the same or similar to any one of the client devices 208(1)-208(n) as described with respect to FIG. 2, including any features or combination of features described with respect thereto. The recipient management device 302 may be the same or similar to the recipient management device 202 as described with respect to FIG. 2, including any features or combination of features described with respect thereto.

Upon being started, the recipient management device 302 executes a process for easily transferring, accessing, and managing recipient details across multiple financial institutions.

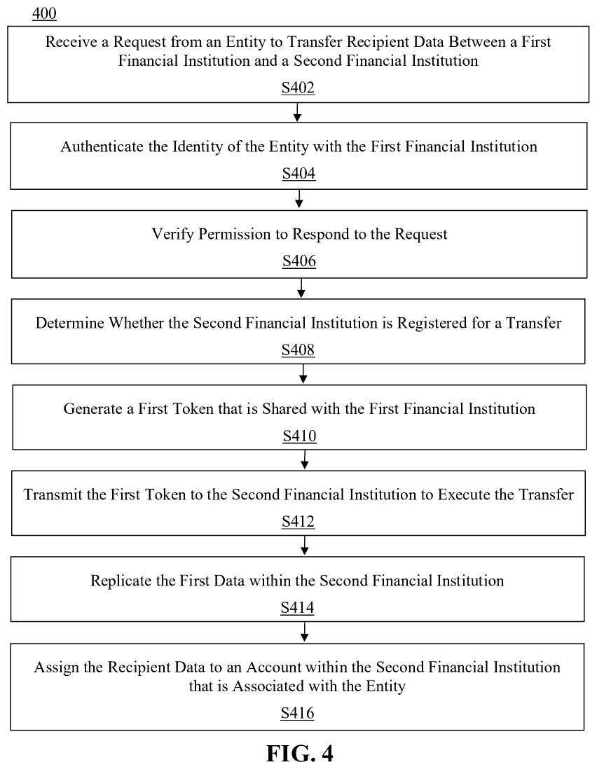

FIG. 4 illustrates a process 400 for easily transferring, accessing, and managing recipient details across multiple financial institutions, according to an embodiment. In process 400 of FIG. 4, at step S402, the recipient management device 302 may be configured to receive a request from an entity to transfer recipient data from a first FI to a second FI. The entity may be an individual client, a company, or business with an account associated with the first FI. The recipient may be an individual, company, or business that receives a single, multiple, or reoccurring payments or money transfers from the entity. The recipient data may include information regarding a preferred mode of transmitting payment. The mode of transmitting payment may include a variety of payments rails or real-time payment systems (e.g., electronic money transfers across an automated clearing house (ACH), wire transfers, Zelle, BillPay, and real-time payments (RTP) electronic money transfer). For example, according to an embodiment, the recipient may be a utility company that is linked to a client's bank account at the first FI for receiving monthly utility payments. The client may open an account at the second FI and request that the recipient details of the utility company be transferred from the first FI to the second FI, so that the utility payments may be made from the client's account at the second FI. In some embodiments, the request may be made via a GUI and the recipient data may also be displayed and modifiable via the GUI. In an embodiment, the recipient management device 302 may be configured to generate an invitation for the recipient to register and provide details and preferences with regard to the receiving of payments and/or transfers. The invitation may allow the recipient to add, delete, or modify their account information, their transmittal information, and their preferences for transmittal and payment.

At step S404, the recipient management device 302 may be configured to authenticate the identity of the entity with the first FI. For example, the recipient management device 302 may be configured to connect with first FI to ensure that the entity requesting the transfer is in fact the owner or authorized manager of the account. And, at step S406, the recipient management device 302 may be configured to verify permission with the first FI for the recipient management device 302 to respond to the transfer request, when the identity of the entity is authenticated. For example, the recipient management device 302 may be configured to ensure that the transfer can be made and is allowed by the first FI.

At step S408, the recipient management device 302 may be configured to determine whether the second FI is registered for a transfer. For example, the recipient management device 302 may be configured to connect to the second FI to: determine whether the second FI is registered for receiving transfers from the recipient management device 302; determine whether the second FI is ready to receive the transfer; and determine whether the second FI has given consent for the transfer.

At step S410, when a determination is made that the second FI is registered, the recipient management device 302 may be configured to generate a first token that is shared with the first FI. The Token may refer to a non-limiting means of authentication and may include multi-factor authentication, certificate based authentication, or blockchain technology. In an embodiment, the token may be a communication key that includes a unique client identifier that may be recognized across FIs. In an embodiment, the recipient management device 302 may be configured to add transaction metadata to the first token. The recipient management device 302 may be configured to later assess the metadata for determining whether the token is valid and/or whether it poses a potential risk. In some embodiments, the recipient management device 302 may also be configured to share the first token with the entity.

At step S412, the recipient management device 302 may be configured to transmit the first token to the second FI for executing the transfer with the second FI. In an embodiment, the second FI may recognize the unique client identifier that is included as part of the first token to verify and start the execution of the transfer. In an embodiment, the recipient management device 302 may be configured to prevent or stop the executing of the transfer if an analysis of the metadata suggests that the token may be invalid or poses a potential risk. In some embodiments, the recipient management device 302 may be configured to transmit the first token and an identity credential of the entity from the entity to the second institution for the executing of the transfer.

At step S414, when the first token is received by the second FI, the recipient management device 302 may be configured to replicate the recipient data from the first FI within the second FI. In some embodiments, modification to the recipient data may be synchronized between the first financial institution and the second financial institution, such that changes or modification to recipient data made at one FI may automatically be made at the other FI.

Then, at step S416, the recipient management device 302 may be configured to assign the replicated data within the second FI to the respective entity or entity account. In some embodiments, the recipient management device 302 may be configured to facilitate the transmission of a payment from the first account associated with the entity to a second account associated with the recipient. In an embodiment, the recipient management device 302 may be configured to generate a notification upon completion of at least one from among the transmitting, the replicating, and the assigning steps. The recipient management device 302 may be configured to transmit the notification to at least one from among the entity, the first financial institution, and the second financial institution.

FIG. 5 illustrates a technical design and flow diagram 500 for easily transferring, accessing, and managing recipient details across multiple financial institutions, according to an embodiment. Particularly, the technical design and flow diagram 500 illustrates the technical implementation of the process 400 from FIG. 4, for an example use case for when a client request recipient replication. The diagram 500 shows a financial institution A 501 and a financial institution B 503 that both have a payment solution 506, as well as a packaged software product 508 that the includes a recipient management service 510. As illustrated by FIG. 5, both financial institution A 501 and a financial institution B 503 use a create, read, update, and delete (CRUD) API for recipient management and the corresponding recipient data is transmitted to a network gateway 516 that is part of the payment recipient management system 505. Additionally, the diagram 500 shows a financial institution C 507 that only includes a payment solution 506. The financial institution C 507 uses a software as a service (SaaS) product through API calls for transmitting the recipient data to the network gateway 516.

As further illustrated by FIG. 5, the network gateway 516 also connects to a security app 522, which includes a user database 520, for access management. The security app 522 connects to an identity provider (iDP) that provides client and recipient identities across multiple FIs. The security app 522 is also connected to a core recipient management service 524 that is configured to receive data from a FI database 528, a client database 532, and a recipient database 530. The combination of the FI database 528, the client database 532, and the recipient database 530 may be the same or similar to the FI, client, and recipient data database 312. The core recipient management service 524 is also connected to the network gateway 516 for managing the transmission of the flow of recipient data. The client 518 may also view and manage the recipient data at the network gateway 516, per access permissions granted from the FIs. Moreover, FI recipients 534 may also register with the network gateway 516 to manage preferences and recipient details.

The flow diagram 500, illustrates a system that enables FIs to choose the solution as a SaaS offering (as shown for financial institution C 507) or as a packaged software product 508 to be installed on their network (as shown for financial institution A 501 and financial institution B 503). In an embodiment, the packaged software product 508 may have configurable options for FIs to install databases, security, and messaging and communication protocols either on premises or in a cloud network. Additionally, the payment recipient management system 505 may be configured to provision permissions for clients to access and modify their recipient data. The payment recipient management system 505 may be configured to provide FIs the offering of dedicated or shared data tenancy. The payment recipient management system 505 may also be configured to provide solutions for the FIs to encrypt the data. The payment recipient management system 505 may be configured to synchronize the FIs with modification of recipient data at scheduled intervals or on demand, and may notify all entities (FIs, client, recipient) for updates. The payment recipient management system 505 may be the same or similar to the recipient management device 302 as described with respect to FIG. 3, including any features or combination of features described with respect thereto.

In an embodiment, the security app 522 may use multi-party authentication, authorization, and role-based access mechanisms. The authorization may assign recipient ownership based on customized rules, for example, as illustrated in table 1 below.

TABLE 1
Security App in Recipient Management System.

| Roles | Access | Description |
|---|---|---|
| FI | Complete | FI has complete ownership on all recipient |
| | Ownership | data created by the payer. FI controls access |
| | | to the payer and recipient. FIs define control |
| | | to share recipient data with other FIs. |
| Client | Admin | FI client has admin access to add, create, |
| | Access | update, modify, and delete the payee. Client |
| | | can define consent for sharing and |
| | | notification of/to the recipient data. |
| Recipient | Provisional | Recipient has provisional access on his/her |
| | Access | details and can register to share his/her |
| | | details across FIs and provide preference on |
| | | funds transfer rails including fee liability. |

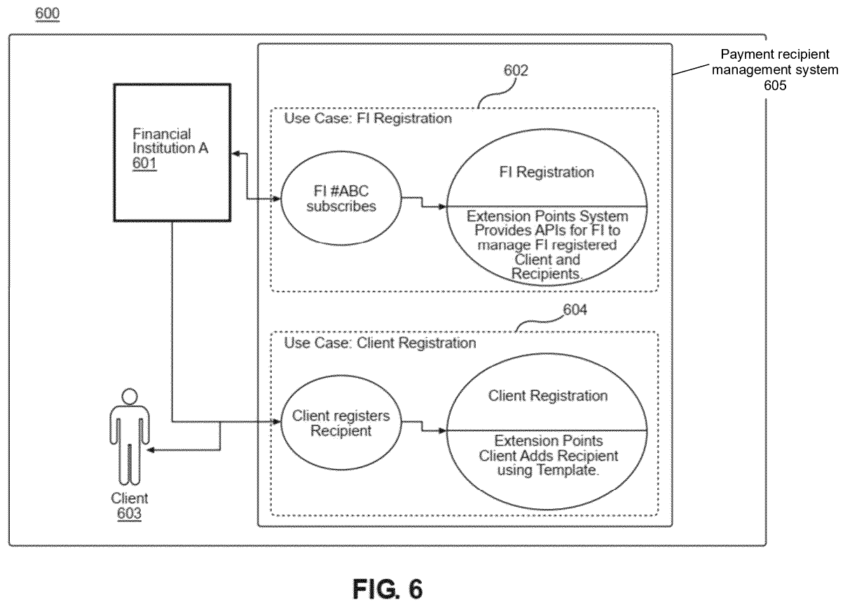

FIG. 6 illustrates an FI and client registration flow diagram 600 for easily transferring, accessing, and managing recipient details across multiple FIs, according to an embodiment. Particularly, the FI and client registration flow diagram 600 illustrates an example use case of the process 400 from FIG. 4 for FI and client registration. The diagram 600 shows a financial institution A 601 in connection with a payment recipient management system 605 that may be configured to authorize and generate unique communication keys between clients, client FIs, recipients, and recipient FIs. The financial institution A 601 may transmit and receive data from a FI registration module 602 of the payment recipient management system 605. At the FI registration module 602, the financial institution A 601 may subscribe to the payment recipient management system 605, in which the payment recipient management system 605 provides APIs for the financial institution A 601 to manage its registered client 603 and recipients.

Also, as illustrated by flow diagram 600, the financial institution A 601 may also be in communication with a client 603, and both the client 603 and the financial institution A 601 may be in communication with a client registration module 604 of the payment recipient management system 605. At the client registration module 604, the client 603 may register the recipients with the payment recipient management system 605, in which the client may add recipients using the template. The client may register in the payment recipient management system 605 via an identifier that is recognized across FIs. In an embodiment, the recipient management system 605 may be configured to provide options to use software for managing the recipient data. For example, the recipient management system 605 may be configured to provide options to use the service as a SaaS solution and make available secure data storage. The payment recipient management system 605 may be the same or similar to the recipient management device 302 and the payment recipient management system 505 as described with respect to FIG. 3 and FIG. 5, including any features or combination of features described with respect thereto.

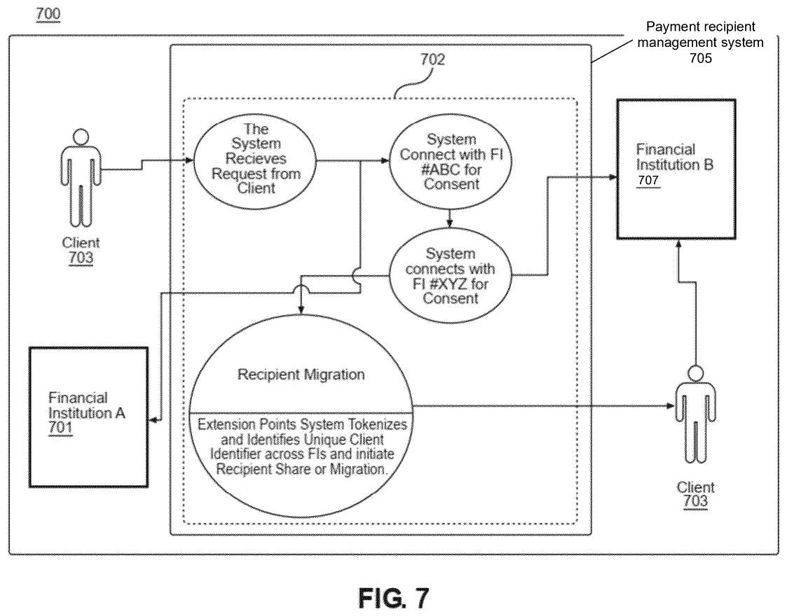

FIG. 7 illustrates a client request recipient replication flow diagram 700 for easily transferring, accessing, and managing recipient details across multiple financial institutions, according to an embodiment. Particularly, the client request recipient replication flow diagram 700 illustrates an example use case of the process 400 from FIG. 4 for when a client requests recipient replication. The diagram 700 shows a client 703 in communication with a payment recipient management system 705 that may be configured to authorize and generate unique communication keys between clients, client FIs, recipients, and recipient FIs. The client 703 may send a request to replicate recipients to a recipient replication module 702 of the payment recipient management system 705. For example, the client 703 may initiate a request to share their recipients associated with financial institution A 701 to financial institution B 707 through the payment recipient management system 705. At the recipient replication module 702, the payment recipient management system 705 communicates with the financial institution A 701 for consent of the replication. For example, the payment recipient management system 705 may connect with financial institution A 701 for authentication and authorization of the client 703 and may verify that there is permission allowed by the financial institution A 701 for such a request. The payment recipient management system 705 also communicates with the financial institution B 707 for consent of the replication. For example, the payment recipient management system 705 may check if the financial institution B 707 is registered for transfer. Upon receiving consent from both the financial institution A 701 and the financial institution B 707, the payment recipient management system 705 identifies and tokenizes a unique client identifier that is recognized across both the financial institution A 701 and the financial institution B 707. For example, the payment recipient management system 705 may generate a unique token-based ticket and share it with the financial institution A 701. The client 703 may submit the ticket information to verify the transfer with the financial institution B 707. The token may then be transmitted to the financial institution B 707 to initiate the replication of the recipients or recipient data at the financial institution B 707. For example, the payment recipient management system 705 may allow the financial institution B 707 to securely replicate the recipient data and get it correctly assigned to client credentials on verification of the unique ticket at the financial institution B 707. The payment recipient management system 705 may be the same or similar to the recipient management device 302, the payment recipient management system 505, and the payment recipient management system 605 as described with respect to FIG. 3, FIG. 5, and FIG. 6, including any features or combination of features described with respect thereto.

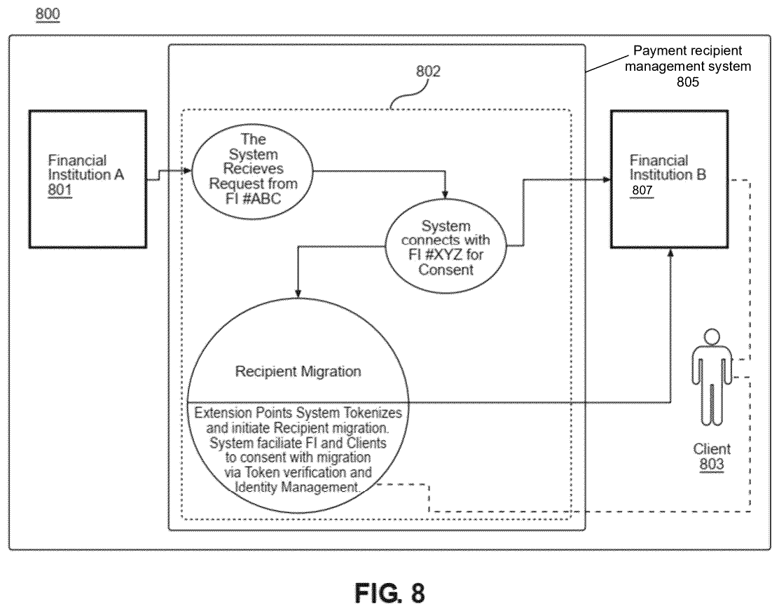

FIG. 8 illustrates a FI merger and acquisitions flow diagram 800 for easily transferring, accessing, and managing recipient details across multiple financial institutions, according to an embodiment. Particularly, the FI merger and acquisitions flow diagram 800 illustrates an example use case of the process 400 from FIG. 4 for FI merger and acquisitions. The diagram 800 shows a financial institution A 801 in communication with a payment recipient management system 805 that may be configured to authorize and generate unique communication keys between clients, client FIs, recipients, and recipient FIs. The financial institution A 801 may send a request to replicate recipients to a recipient replication module 802 of the payment recipient management system 805. For example, the financial institution A 801 may initiate a request to share all their recipient data with financial institution B 807 through the payment recipient management system 805. At the recipient replication module 802, the payment recipient management system 805 communicates with the financial institution B 807 for consent of the replication. For example, the payment recipient management system 805 may check if the financial institution B 807 is registered for transfer. Upon receiving consent from the financial institution B 807, the payment recipient management system 805 identifies and tokenizes a unique client identifier that is recognized across both the financial institution A 801 and the financial institution B 807. For example, the payment recipient management system 805 may generate a unique token-based ticket per clients for the financial institution A 801 and share the ticket details with the financial institution A 801. The payment recipient management system 805 may verify the recipient details across both the financial institution A 801 and the financial institution B 807 and provide a consolidated form of the ticket to the financial institution B 807. The payment recipient management system 805 may also add addenda information such as transaction metadata along with recipient migration for validity and risk check. The financial institution B 807 may share the ticket details to the client 803 for cross verification. The client 803 may use the ticket and their identity credentials in the payment recipient management system 805 for verification and corrections. The payment recipient management system 805 may be the same or similar to the recipient management device 302, the payment recipient management system 505, the payment recipient management system 605, and the payment recipient management system 705 as described with respect to FIG. 3, FIG. 5, FIG. 6, and FIG. 7, including any features or combination of features described with respect thereto.

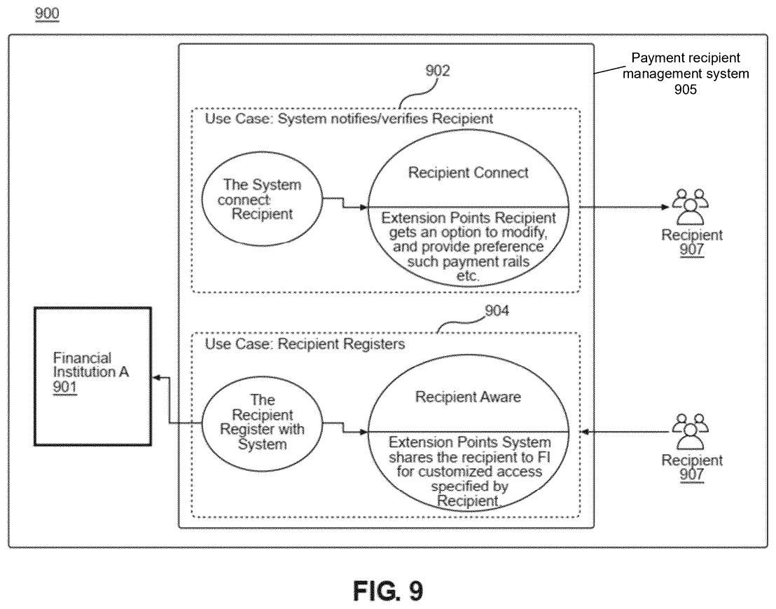

FIG. 9 illustrates a recipient notification and registration flow diagram 900 for easily transferring, accessing, and managing recipient details across multiple financial institutions, according to an embodiment. Particularly, the recipient notification and registration flow diagram 900 illustrates an example use case of the process 400 from FIG. 4 for recipient notification and registration. The diagram 900 shows a recipient notification module 902, as part of the payment recipient management system 905, in communication with the recipients 907. The payment recipient management system 905 may invite the recipient 907 to register. In an embodiment, the invitation to the recipients 907 may be controlled by the financial institution A 901 or the client. Upon recipient registration, the payment recipient management system 905 may provide APIs to update the recipients 907 details. The payment recipient management system 905 may provide APIs for the recipients 907 to set their preference for payment rail. The payment recipient management system 905 may also provide additional controls to manage fee liability for better or faster payment rail.

Additionally, the diagram 900 shows the recipients 907 in communication with a recipient registration module 904, as part of the payment recipient management system 905, which is also in communication with a financial institution A 901. In an embodiment, the recipients 907 may register as users in the payment recipient management system 905. The payment recipient management system 905 may provide the recipients 907 APIs for adding account details required for their preferred payment rail. The payment recipient management system 905 may also provide APIs for the recipients 907 to broadcast towards FI and its clientele for consensus and availability. The payment recipient management system 905 may be the same or similar to the recipient management device 302, the payment recipient management system 505, the payment recipient management system 605, the payment recipient management system 705, and the payment recipient management system 805 as described with respect to FIG. 3, FIG. 5, FIG. 6, FIG. 7, and FIG. 8, including any features or combination of features described with respect thereto.

Accordingly, with this technology, an optimized process for easily transferring, accessing, and managing recipient details across multiple financial institutions is provided.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

1. A method for managing and accessing recipient information between institutions, the method being implemented by at least one processor, the method comprising:
receiving, by the at least one processor, a request from an entity to transfer first data associated with a recipient between a first financial institution and a second financial institution;
authenticating, by the at least one processor, an identity of the entity with the first financial institution by connecting with the first financial institution to verify that the entity has authorization for initiating the transfer;
when the identity of the entity is authenticated, verifying, by the at least one processor, permission to respond to the request with the first financial institution;
when the permission is verified, determining, by the at least one processor, whether the second financial institution is registered for a transfer;
when a determination is made that the second financial institution is registered, generating, by the at least one processor, a first blockchain token that is shared with the first financial institution, wherein the first blockchain token includes a first client identifier that is recognized by the first financial institution and the second financial institution;
transmitting, by the at least one processor, the first blockchain token to the second financial institution for executing the transfer with the second financial institution, wherein the second financial institution identifies the first client identifier to start the executing of the transfer;
when the first blockchain token is received by the second financial institution, replicating, by the at least one processor, the first data within the second financial institution; and
assigning, by the at least one processor, the first data to a first account within the second financial institution associated with the entity.

2. The method of claim 1, further comprising:
displaying, by the at least one processor via a graphical user interface (GUI), the first data, wherein the first data is modifiable via the GUI, and wherein a modification to the first data is synchronized between the first financial institution and the second financial institution.

3. The method of claim 1, further comprising:
adding, by the at least one processor, transaction metadata to the first blockchain token to be used for assessing a validity and a possibility of a potential risk during the executing of the transfer.

4. The method of claim 1, wherein the first blockchain token is shared with the entity, and wherein the entity transmits the first blockchain token and an identity credential to the second financial institution for the executing of the transfer.

5. The method of claim 1, further comprising:
generating, by the at least one processor, a notification upon completion of at least one from among the transmitting, the replicating, and the assigning, wherein the notification is transmitted to at least one from among the entity, the first financial institution, and the second financial institution.

6. The method of claim 1, further comprising:
generating, by the at least one processor, an invitation for the recipient to register and provide at least one detail associated with the recipient, wherein the at least one detail includes at least one from among account information associated with the recipient and transmittal information associated with the recipient.

7. The method of claim 1, wherein the first data includes information regarding a preferred mode of transmitting payment, wherein the preferred mode of transmitting payment is selected from among an electronic money transfer across an automated clearing house (ACH), a wire transfer, and a real-time payments (RTP) electronic money transfer.

8. The method of claim 1, further comprising:
controlling, by the at least one processor, access of the first data to a network gateway via an application programming interface (API), wherein the network gateway is in connection with a security application that assigns authorization access based on a series of predetermined rules for accessing the first data,
when the security application assigns authorization access to the first financial institution and the second financial institution, transmitting, by the at least one processor, a payment from the first account to a second account associated with the recipient based on the first data.

9. The method of claim 1, further comprising:
offering, by the at least one processor, to provide at least one from among a dedicated data tenancy and a shared data tenancy to at least one from among the first financial institution and the second financial institution.

10. A computing apparatus for managing and accessing recipient information between institutions, the computing apparatus comprising:
a processor;
a memory; and
a communication interface coupled to each of the processor and the memory,
wherein the processor is configured to:
receive, via the communication interface, a request from an entity to transfer first data associated with a recipient between a first financial institution and a second financial institution;
authenticate an identity of the entity with the first financial institution by connecting with the first financial institution to verify that the entity has authorization for initiating the transfer;
when the identity of the entity is authenticated, verify permission to respond to the request with the first financial institution;
when the permission is verified, determine whether the second financial institution is registered for a transfer;
when a determination is made that the second financial institution is registered, generate a first blockchain token that is shared with the first financial institution, wherein the first blockchain token includes a first client identifier that is recognized by the first financial institution and the second financial institution;
transmit, via the communication interface, the first blockchain token to the second financial institution for executing the transfer with the second financial institution, wherein the second financial institution identifies the first client identifier to start the executing of the transfer;
when the first blockchain token is received by the second financial institution, replicate the first data within the second financial institution; and
assign the first data to a first account within the second financial institution associated with the entity.

11. The computing apparatus of claim 10, wherein the processor is further configured to:
display, via a graphical user interface (GUI), the first data, wherein the first data is modifiable via the GUI, and wherein a modification to the first data is synchronized between the first financial institution and the second financial institution.

12. The computing apparatus of claim 10, wherein the processor is further configured to:
add transaction metadata to the first blockchain token to be used for assessing a validity and a possibility of a potential risk during the executing of the transfer.

13. The computing apparatus of claim 10, wherein the first blockchain token is shared with the entity, and wherein the entity transmits, via the communication interface, the first blockchain token and an identity credential to the second financial institution for the executing of the transfer.

14. The computing apparatus of claim 10, wherein the processor is further configured to:
generate a notification upon completion of at least one from among the transmitting, the replicating, and the assigning, wherein the notification is transmitted to at least one from among the entity, the first financial institution, and the second financial institution.

15. The computing apparatus of claim 10, wherein the processor is further configured to:
generate an invitation for the recipient to register and provide at least one detail associated with the recipient, wherein the at least one detail includes at least one from among account information associated with the recipient and transmittal information associated with the recipient.

16. The computing apparatus of claim 10, wherein the first data includes information regarding a preferred mode of transmitting payment, wherein the preferred mode of transmitting payment is selected from among an electronic money transfer across an automated clearing house (ACH), a wire transfer, and a real-time payments (RTP) electronic money transfer.

17. The computing apparatus of claim 10, wherein the processor is further configured to:
control access of the first data to a network gateway via an application programming interface (API), wherein the network gateway is in connection with a security application that assigns authorization access based on a series of predetermined rules for accessing the first data,
when the security application assigns authorization access to the first financial institution and the second financial institution, transmit, via the communication interface, a payment from the first account to a second account associated with the recipient based on the first data.

18. The computing apparatus of claim 10, wherein the processor is further configured to:
offer to provide at least one from among a dedicated data tenancy and a shared data tenancy to at least one from among the first financial institution and the second financial institution.

19. A non-transitory computer readable storage medium storing instructions for managing and accessing recipient information between institutions, the storage medium comprising executable code which, when executed by a processor, causes the processor to:
receive a request from an entity to transfer first data associated with a recipient between a first financial institution and a second financial institution;
authenticate an identity of the entity with the first financial institution by connecting with the first financial institution to verify that the entity has authorization for initiating the transfer;
when the identity of the entity is authenticated, verify permission to respond to the request with the first financial institution;
when the permission is verified, determine whether the second financial institution is registered for a transfer;
when a determination is made that the second financial institution is registered, generate a first blockchain token that is shared with the first financial institution, wherein the first blockchain token includes a first client identifier that is recognized by the first financial institution and the second financial institution;
transmit the first blockchain token to the second financial institution for executing the transfer with the second financial institution, wherein the second financial institution identifies the first client identifier to start the executing of the transfer;
when the first blockchain token is received by the second financial institution, replicate the first data within the second financial institution; and
assign the first data to a first account within the second financial institution associated with the entity.

20. The storage medium of claim 19, wherein when executed by the processor, the executable code further causes the processor to:
display, via a graphical user interface (GUI), the first data, wherein the first data is modifiable via the GUI, and wherein a modification to the first data is synchronized between the first financial institution and the second financial institution.
